(19) United States
(12) Patent Application Publication
(10) Pub. No.: US 2011/0153344 A1
(43) Pub. Date: Jun. 23, 2011

(54) METHODS AND APPARATUS FOR INTEGRATED MEDICAL CASE RESEARCH AND COLLABORATION

(75) Inventor: Guy Robert Vesto, Kildeer, IL (US)

(73) Assignee: GENERAL ELECTRIC COMPANY, A NEW YORK CORPORATION, Schenectady, NY (US)

(21) Appl. No.: 12/646,615

(22) Filed: Dec. 23, 2009

(51) Int. Cl. G06Q 50/00

(52) U.S. Cl. 705/2

(57) ABSTRACT

Methods and apparatus for medical case research and collaboration are disclosed herein. An example method includes receiving, by a processor, information from a person via a research tool related to one or more health issues of the person; generating a medical case based on the information received from the person; calculating one or more likelihoods associated with one or more potential causes of the health issues, wherein a first one of the likelihoods indicates a probability that a first one of the potential causes of the health issue is an accurate diagnosis; determining whether the one or more likelihoods indicate that the medical case is complex; and when the medical case is complex, granting the person access to a collaboration module.

### FIELD OF THE DISCLOSURE

The present disclosure relates generally to information systems and, more particularly, to methods and apparatus for integrated medical case research and collaboration.

### BACKGROUND

Persons experiencing health issues often attempt to perform self-diagnoses using one or more sources of medical information. Communication networks, such as the Internet, provide access to websites, blogs, forums, and/or other resources dedicated to enabling self-diagnoses. While some may find answers to their health-related questions using such resources, the vast amount of information and inherent complexity of health-related issues lead to misdiagnoses, confusion, inappropriate treatments, missed issues, and other types of problems.

### SUMMARY

An example computer implemented method includes receiving, by a processor, information from a person via a research tool related to one or more health issues of the person. Further, the example computer implemented method includes generating a medical case based on the information received from the person. Further, the example computer implemented method includes calculating one or more likelihoods associated with one or more potential causes of the health issues, wherein a first one of the likelihoods indicates a probability that a first one of the potential causes of the health issue is an accurate diagnosis. Further, the example computer implemented method includes determining whether the one or more likelihoods indicate that the medical case is complex. Further, the example computer implemented method includes, when the medical case is complex, granting the person access to a collaboration module.

An example tangible machine readable medium has instructions stored thereon that, when executed, cause a machine to receive information from a person via a research tool related to one or more health issues of the person. Further, the example tangible machine readable medium has instructions stored thereon that, when executed, cause a machine to generate a medical case based on the information received from the person. Further, the example tangible machine readable medium has instructions stored thereon that, when executed, cause a machine to calculate one or more likelihoods associated with one or more potential causes of the health issues, wherein a first one of the likelihoods indicates a probability that a first one of the potential causes of the health issue is an accurate diagnosis. Further, the example tangible machine readable medium has instructions stored thereon that, when executed, cause a machine to determine whether the one or more likelihoods indicate that the medical case is complex. Further, the example tangible machine readable medium has instructions stored thereon that, when executed, cause a machine to, when the medical case is complex, grant the person access to a collaboration module.

An example apparatus includes a research tool to receive information from a person related to one or more health issues of the person. Further, the example apparatus includes a medical case builder to generate a medical case based on the information received from the person. Further, the example apparatus includes a case analyzer to calculate one or more likelihoods associated with one or more potential causes of the health issues, wherein a first one of the likelihoods indicates a probability that a first one of the potential causes of the health issue is an accurate diagnosis, and wherein the case analyzer is to determine whether the one or more likelihoods indicate that the medical case is complex, and wherein the case analyzer is to grant the person access to a collaboration module when the case analyzer determines that the medical case is complex.

### BRIEF DESCRIPTION OF THE DRAWINGS

FIG. 1 is a block diagram of an example medical information system including an example decision support assisted research module (DSARM) and an example medical case collaboration module (MCCM).

FIG. 2 is a block diagram of an example apparatus that may be used to implement of the example DSARM of FIG. 1.

FIG. 3 is a screenshot associated with an example implementation of the example DSARM of FIGS. 1 and/or 2.

FIG. 4 is a block diagram of an example apparatus that may be used to implement of the example MCCM of FIG. 1.

FIG. 5 is a screenshot associated with an example implementation of the example MCCM of FIGS. 1 and/or 4.

FIG. 6 is a flow diagram representative of example machine readable instructions that may be executed to implement the example DSARM of FIGS. 1 and/or 2.

FIG. 7 is a block diagram of an example processor system that may be used to execute the machine readable instructions of FIG. 6 and/or to implement the example methods, apparatus, systems, and/or articles of manufacture described herein.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Patients with chronic conditions and/or diseases that are difficult to diagnose and/or treat (e.g., lupus, multiple sclerosis, fibromyalgia, chronic fatigue syndrome, Lyme disease, etc.) often enter healthcare systems and are shuffled, immediately or after a failure of a primary practitioner to diagnose the patients, from one practitioner (e.g., a specialist) to another. In many instances, one or more of the practitioners lack sufficient context as a result of, for example, a failure to share patient information (e.g., among the other practitioners). Therefore, multiple practitioners treating the same patient often repeat diagnostic tests and ask the patients repetitive questions. This process rapidly becomes expensive, consuming and, frustrating for many patients.

Faced with limited options, some patients utilize alternative sources of information such as, for example, websites, blogs, forums, and/or other types of online resources (e.g., symptom checkers, self-diagnosis tools, etc.). While additional information can improve the patients' understanding of medical conditions or issues, these resources can be overwhelming and confusing, especially for a non-medically trained person. For example, information regarding a disease or condition from a first resource may contradict information regarding that disease or condition from a second resource. Furthermore, as almost anyone can create and/or contribute to these types of resources (e.g., websites, blogs, etc.), the information on these resources is sometimes inaccurate, causing more harm than good. For example, inaccurate or poor information on widely available resources can lead to dissemination of the erroneous information, self-mistreatment and misdiagnosis, which in turn can lead to mistreatment or unnecessary worry, misunderstanding, and/or or misinterpretation of medical conditions or issues.

The example methods, apparatus, systems, and/or articles of manufacture described herein provide patients with research tools to gather medical information related to one or more health issues and/or to receive analysis results (e.g., medical suggestions) related to the presented health issues. Generally, the example research tools described herein create a patient profile for a particular patient and receive and/or collect information related to the patient. The example research tools analyze the received and/or collected information and generate analyses of the medical case associated with the patients.

Furthermore, the example methods, apparatus, systems, and/or articles of manufacture described herein provide collaboration tools for patients having, for example, chronic conditions and/or diseases which are difficult to diagnose and/or treat. When the analyses of the example research tools indicate that the corresponding patient is likely experiencing chronic condition(s) and/or may have a disease that is difficult to diagnose and/or treat, the patient is granted access to the example collaboration tools described herein. Generally, the example collaboration tools enable patients to, for example, request advice on diagnosis, seek second or third opinions in additional to that provided by a previous practitioner, become informed of experimental treatments and/or clinical trials, etc. Additional aspects and advantages of the example methods, apparatus, systems, and/or articles of manufacture are described in greater detail herein.

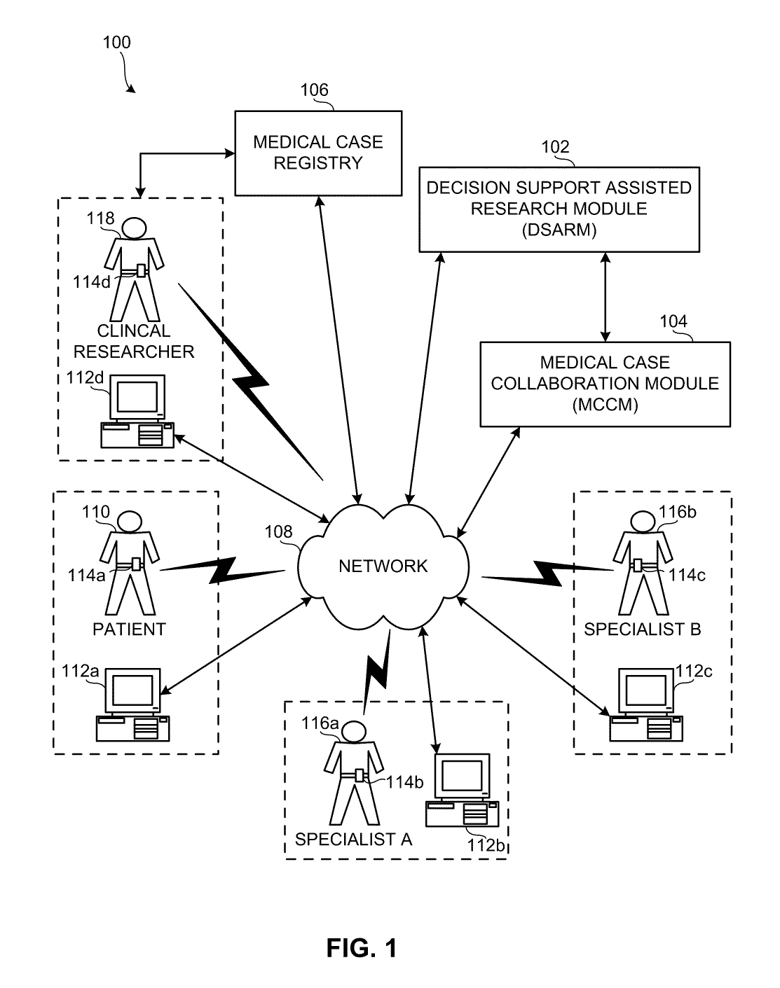

FIG. 1 is a block diagram of an example medical information system 100 including a decision support assisted research module (DSARM) 102, a medical case collaboration module (MCCM) 104, and a medical case registry 106. In the illustrated example, the DSARM 102, the MCCM 104, and the medical case registry 106 are communicatively coupled to a network 108. The network 106 may be implemented by, for example, the Internet, an intranet, a private network, a wired or wireless Local Area Network, a wired or wireless Wide Area Network, a cellular network, and/or any other suitable network. Additionally or alternatively, the DSARM 102, the MCCM 104, and/or the medical case registry 106 can communicate directly (e.g., without communicating via the network 108). In some examples, the DSARM 102, the MCCM 104, and/or the medical case registry 106 are implemented in a similar location (e.g., a central server and/or a bank of servers) as a part of a core medical information system.

A patient 110, via a workstation 112a and/or a mobile media device 114a is in communication with the network 108 and, thus, the example DSARM 102, the example MCCM 104, and/or the example medical case registry 106. A first specialist 116a (labeled ‘Specialist A’ in the example of FIG. 1), via a workstation 112b and/or a mobile media device 114b is in communication with the network 108 and, thus, the example DSARM 102, the example MCCM 104, and/or the example medical case registry 106. A second specialist 116b (labeled ‘Specialist B’ in the example of FIG. 1), via a workstation 112c and/or a mobile media device 114c is in communication with the network 108 and, thus, the example DSARM 102, the example MCCM 104, and/or the example medical case registry 106. A clinical researcher 118, via a workstation 112d and/or a mobile media device 114d, is in communication with the network 108 and, thus, the example DSARM 102, the example MCCM 104, and/or the example medical case registry 106. Further, the clinical researcher 118 has direct access (e.g., without communicating via the network 108) to the example medical case registry 106.

The example workstations 112a-d may be any equipment (e.g., a personal computer, terminal, etc.) capable of executing software that permits users to interact with electronic data. The example mobile media devices 114a-d are portable devices (e.g., personal digital assistants (PDAs), smartphones (e.g., an Apple® iPhone® or iTouch®, a Blackberry® smartphone) and/or any other portable computing devices having wired or wireless access to the network 108). The example methods, apparatus, systems, and/or articles of manufacture described herein may be integrated with one or more of the workstations 112a-d and/or mobile media devices 114a-d (e.g., as a software package capable of being installed and executed on a computing device) and/or may be implemented on a dedicated device. The mobile media devices 114a-d can be coupled (e.g., via a wired and/or wireless connection) to the workstations 112a-d, respectively, to communicate therewith (e.g., to perform a synchronization of data).

Generally, the example DSARM 102 enables the patient 110 to perform a plurality of research operations related to health issues, symptoms, possible causes of symptoms or conditions, etc. For example, the patient 110 can enter one or more symptoms that the patient 110 is experiencing or has experienced and, in some examples, the DSARM 102 may provide the patient 110 with related information (e.g., potential causes of the symptoms) based on the symptoms entered by the patient 110. Additionally, the patient 110 can use the DSARM 102 to search for medical terminology and/or clinical concepts. The example DSARM 102 can provide any other types of research capabilities and/or tools that provide the patient 110 with medical information and/or analyses involving medical information associated with the patient 110.

When the patient 110 accesses the DSARM 102, the DSARM 102 creates and stores a profile for the patient 110. The profile initially includes basic information related to patient 110 (e.g., biographic, demographic, etc.). As the patient 110 performs research operations (e.g., by entering symptoms), the DSARM 102 updates the patient profile by building a medical case associated with the patient 110. Further, the DSARM 102 integrates information from a personal health record of the patient 110 into the medical case. The example DSARM 102 uses additional or alternative information (e.g., data from a medical symptom knowledge database, the medical case registry 106, and/or any other suitable source of information) to build and/or update the medical case associated with the patient 110.

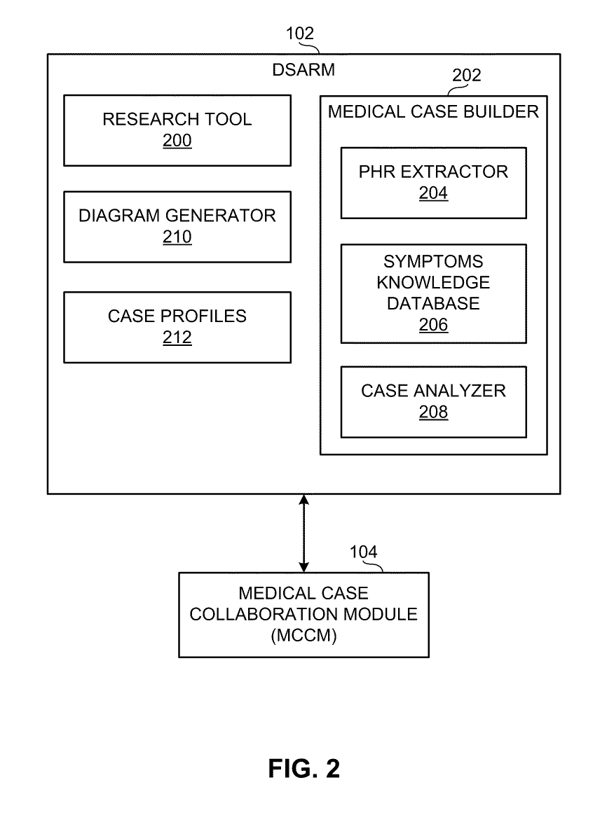

The example DSARM 102 uses the medical case associated with the patient 110 to calculate one or more likelihoods of one or more causes behind the symptoms entered into the DSARM 102. If the calculated likelihoods indicate that the patient 110 has a difficult disease to diagnose (e.g., if the disease or condition from which the patient 110 is suffering is not easily identified) and/or if the calculated likelihoods indicate that the patient 110 is suffering from a chronic condition (e.g., based on timelines entered into the DSARM 102 in association with the symptoms), the DSARM 102 grants the patient 110 access to the example MCCM 104. The example DSARM 102 is described in greater detail below in connection with FIG. 2.

Generally, the example MCCM 104 provides the patient 110 with a plurality of collaboration tools particularly useful for someone having difficulty obtaining a diagnosis and/or suffering from a chronic condition. For example, the MCCM 104 can provide additional, specialized information aimed at narrowing down the potential causes of the symptoms. Further, the example MCCM 104 can monitor, for example, a personal health record corresponding to the patient 110, inform the patient 110 of newly available test results, and/or updated the medical case associated with the patient 110 in the DSARM 102 based on the newly available test results. The example MCCM 104 also provides the patient 110 with information related clinical trials and/or experimental treatments related to the symptoms of the patient 110 and/or links to additional information provided by, for example a governmental health agency (e.g., the Agency for Healthcare Quality and Research (AHRQ)).

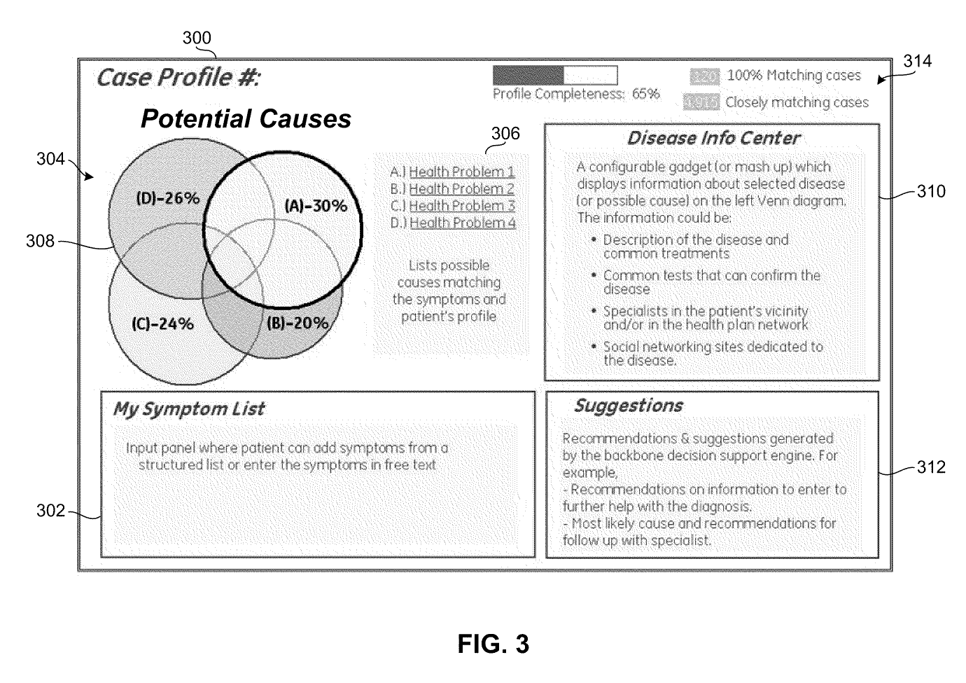

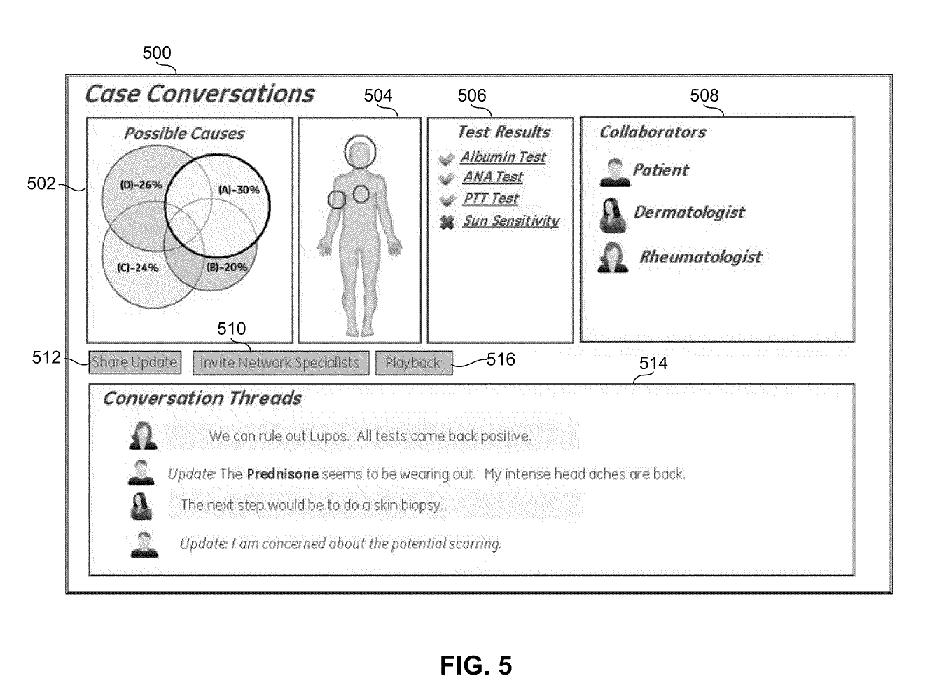

Further, the example MCCM 104 can inform the patient 110 of specialists within a network (e.g., a network to which the patient 110 belongs) and/or within a geographic area defined by, for example, the patient 110. In the illustrated example of FIG. 1, the MCCM 104 informs the patient 110 of the first and second specialists 116a and 116b. The first and second specialists 116a and 116b may be of similar or different disciplines that the MCCM 104 determines are potentially (or likely) related to the symptoms of the patient 110. As described in detail below, the example MCCM 104 can also facilitate communication(s) between the patient 110 and the specialist(s) 116a and/or 116b. The patient 110, the first specialist 116a, and/or the second specialist 116b can use a corresponding one of the workstations 112a-c and/or mobile media devices 114a-c to interact with the example MCCM 104 to, for example, post a question, respond to a question, update information (e.g., based on test results), make suggestions, etc. Additional aspects and advantages of the example MCCM 104 and the collaborations facilitated thereby are described in greater detail below in connection with FIGS. 3 and 5.

The example medical case registry 106 includes medical cases that can be used by, for example the clinical researcher 118 and/or other healthcare practitioners. In the illustrated example, the medical case registry 106 includes the medical cases generated by the example DSARM 102 and/or maintained (e.g., updated according to a monitored personal health record) by the example MCCM 104. The clinical researcher 118 and/or other entities can use the information of the example medical case registry 106 to perform studies, calculate and/or utilize trend information, design targeted surveys or queries for the general patient population, design and/or test wellness or disease prevention programs, etc. Additionally or alternatively, the medical case registry 106 can by used for statistical purposes by the clinical researcher 118 and/or other entities to identify, for example, improvement opportunities for diagnosis algorithms, determine a number of unresolved cases involving certain symptom(s) (e.g., symptoms typically indicative of a disease that is difficult to diagnose, such as Lupus), calculate a frequency at which certain disease(s) are misdiagnosed, determine an average number of specialists consulted by patients having symptoms of a certain disease, etc. Additionally or alternatively, the example medical case registry 106 can be used by the example DSARM 102 and/or the example MCCM 104 to, for example, provide medical and/or statistical information (e.g., regarding other patients and/or numbers thereof suffering from similar symptoms and/or unresolved or undiagnosed conditions).

FIG. 2 is a block diagram of an example apparatus that may be used to implement the example DSARM 102 of FIG. 1. The example DSARM 102 of FIG. 2 includes a research tool 200, a medical case builder 202 having a personal health record (PHR) extractor 204, a symptoms knowledge database 206, and a case analyzer 208, a diagram generator 210, and one or more case profiles 212. While an example manner of implementing the example DSARM 102 of FIG. 1 has been illustrated in FIG. 2, one or more of the elements, processes and/or devices illustrated in FIG. 2 may be combined, divided, re-arranged, omitted, eliminated and/or implemented in any other way. Further, the example research tool 200, the example medical case builder 202, the example PHR extractor 204, the example symptoms knowledge database 206, the example case analyzer 208, the example diagram generator 210, the example case profiles 212, and/or, more generally, the example DSARM 102 of FIG. 2 may be implemented by hardware, software, firmware and/or any combination of hardware, software and/or firmware. Thus, for example, any of the example research tool 200, the example medical case builder 202, the example PHR extractor 204, the example symptoms knowledge database 206, the example case analyzer 208, the example diagram generator 210, the example case profiles 212, and/or, more generally, the example DSARM 102 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example research tool 200, the example medical case builder 202, the example PHR extractor 204, the example symptoms knowledge database 206, the example case analyzer 208, the example diagram generator 210, the example case profiles 212, and/or, more generally, the example DSARM 102 of FIG. 2 are hereby expressly defined to include a tangible medium such as a memory, DVD, CD, etc., storing the software and/or firmware. Further still, the example research tool 200, the example medical case builder 202, the example PHR extractor 204, the example symptoms knowledge database 206, the example case analyzer 208, the example diagram generator 210, the example case profiles 212, and/or, more generally, the example DSARM 102 of FIG. 2 may include one or more elements, processes and/or devices in addition to, or instead of, those illustrated in FIG. 2, and/or may include more than one of any or all of the illustrated elements, processes and devices.

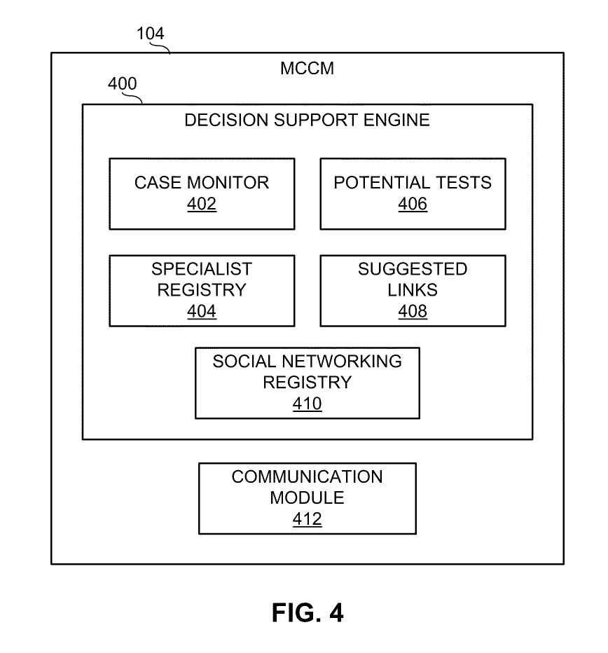

As shown in FIG. 2, the example DSARM 102 interacts with and is supported by the example MCCM 104. More specifically, as described in greater detail below in connection with FIG. 4, the example MCCM 104 includes a decision support engine 400 that interacts with the example DSARM 102 by, for example, providing suggestions and/or advice to the patient 110 regarding, for example, how to narrow a list of potential causes of one or more symptoms. The decision support engine 400 of FIG. 4 is described in detail below.

When the patient 110 of FIG. 1 accesses the example DSARM 104 of FIG. 2, a case profile corresponding with the patient 110 is created and stored in the case profiles 212. In particular, upon accessing the example DSARM 102 (e.g., logging onto the DSARM 102 via the network 108 of FIG. 1), a user interface is presented to the patient 110 (e.g., on a display device of the workstation 112a and/or the mobile media device 114a). The example user interface prompts the patient 110 for initial information (e.g., biographic information) that can be used to create a case profile for the patient 110.

When the case profile corresponding to the patient 110 is created and stored in the case profiles 212, the patient 110 can then use the research tool 200 to perform one or more research activities or operations (e.g., looking up symptoms and potential causes therefore, searching for medical terminology, reviewing medical publications, etc.). In some examples, the research tool 200 is an online application, accessible of the network 108 free of charge. In some examples, the research tool 200 is accessible via a gadget or widget (e.g., an accelerator gadget) executable by, for example, a web browser. Such a gadget or widget can enable the patient 110 to enter a search term into a blank field and to be linked to the research tool 200 (e.g., by the research tool 200 performing the requested search) in response to activating the gadget or widget. The information of the case profiles 212 can be provided (e.g., exported in electronic format, on a memory card, printed report, compact disc(CD), etc.) to one or more qualified or approved entities including, for example, a primary care physician, specialist(s), family members, other patients

In the illustrated example, the research tool 200 receives one or more symptoms from the patient 110 via a user interface. For purposes of illustration, FIG. 3 shows an example screenshot of an example user interface 300 implemented in connection with the example DSARM of FIGS. 1 and/or 2 or, more particularly, the example research tool 200. The example user interface 300 includes a symptoms window 302 configured as an input panel. The patient 110 can enter symptoms to the symptoms window 302 from a structured list, in free text, and/or select one or more symptoms from a search result list generated in response to a search for medical terminology by the patient 110 via the research tool 200. Additional aspects of the example user interface 300 of FIG. 3 are described below.

The example medical case builder 202 of FIG. 2 receives data entered into the research tool 200 by the patient 110 (e.g., via the symptoms window 302 of FIG. 3). The example medical case builder 202 adds the input received in the example symptoms window 302 of FIG. 3 to the case profile corresponding to the patient 110 as a basis for a medical case to be element of the case profile. In particular, the example medical case builder 202 assembles structured clinical documents (e.g., documents based on the HL7 Clinical Data Architecture) reflecting the medical case of the patient 110. One or more elements of the medical case associated with the patient 110 can be exported or conveyed to, for example, a healthcare practitioner using different tools of the research tool 200 (e.g., an email application and/or any other suitable application for transferring electronic data).

To further assemble the medical case for the patient 110, the example personal health record (PHR) extractor 204 of the example medical case builder 202 obtains information (e.g., medical and/or demographic information) from one or more PHRs associated with the patient 110. The patient 110 may have one or more PHRs in one or more medical information systems (e.g., electronic medical record (EMR) systems, medical information sharing systems) accessible by the example PHR extractor 204. The PHR(s) include different types of information including, for example, medical summaries of clinical episodes, tests, examinations, etc. generated by primary practitioners, specialists, etc., and/or the actual results of the clinical episodes, tests, examinations, etc. The example PHR extractor 204 of FIG. 2 is capable of identifying information within the PHR(s) that is related to symptoms currently being experienced by the patient 110 (e.g., the symptoms entered into the symptoms window 302 and/or symptoms of the medical case of the patient 110). The example medical case builder 202 adds the information extracted by the example PHR extractor 204 to the medical case of the patient 110.

The example medical case builder 202 references the example symptoms knowledge database 206 to obtain one or more potential causes of the symptoms of the medical case created based on, for example, the information entered into the research tool by the patient 110 (e.g., via the symptoms window 302) and/or the information obtained by the PHR extractor 204. The one or more potential causes obtained from the example symptoms knowledge database 206 are added to the medical case associated with the patient 110.

The example case analyzer 208 analyzes the potential cause(s) obtained via the example symptoms knowledge database 206 and calculates a likelihood (e.g., which may include a margin of error and/or some other type of indications of calculation parameters) for each of the potential cause(s). Each calculated likelihood reflects a probability that the corresponding cause is the correct diagnosis. The calculated likelihoods are added to the medical case of the patient 110. In the illustrated example of FIG. 2, the example case analyzer 208 implements an algorithm to categorize the medical case based on the calculated likelihoods. In particular, the example case analyzer 208 of FIG. 2 creates a ‘simple case’ category to include cases that are easily diagnosed. The example case analyzer 208 may assign a medical case to the ‘simple case’ category when, for example, one of the calculated likelihoods is greater than a certain threshold and/or when the number of potential causes identified via the symptoms knowledge database 206 is less than a certain threshold. The example case analyzer 208 of FIG. 2 also creates a ‘complex case’ category to includes cases that are not easily diagnosed (e.g., certain chronic diseases). In some examples, the ‘complex case’ category can be separated into two sub-categories such as, for example, rule-based chronic diseases (e.g., diabetes, hypertension, etc.) and counter-intuitive chronic diseases (e.g., diseases in which a diagnosis is not easily identifiable, such as Lupus, Alzheimer's, Parkinsons, chronic fatigue, Lyme disease, Fibromyalgia, multiple sclerosis, progressive multifocal leukoencephalopathy (PMLE), etc.).

In the illustrated example of the FIG. 3, the example user interface 300 includes a potential causes section 304 that displays the potential causes of the medical case associated with the patient 110 as identified by the example medical case builder 202 and, more specifically, the example symptoms knowledge database 206. The example potential causes section 304 includes a list 306 of potential causes of the patient's symptoms based on the medical case (e.g., the symptoms entered by the patient 110 and the information of the PHR(s) associated with the patient 110). Furthermore, the example potential causes section 304 of FIG. 3 includes a diagram 308 generated by the example diagram generator 210 of FIG. 2. The example diagram 308 is a graphical representation of the calculations performed by the example case analyzer 208. In the illustrated example of FIG. 3, the diagram 308 is a Venn diagram reflecting unions between the calculated likelihoods of the medical case. That is, the example diagram generator 210 of the illustrated example generates data indicative of one or more overlaps between the calculated likelihoods and formats the data such that a Venn diagram can be presented to the patient 110 using the research tool 200. The data generated by the diagram generator 210 (e.g., the example diagram 308 of FIG. 3) is stored as an element of the medical case in the case profiles 212. Further, the example diagram generator 210 can be generate additional data when more information becomes available to via, for example, the research tool 200 from the patient 110 and/or the PHR extractor 204 as more medical information related to the patient 110 becomes available (e.g., new test results from one or more PHRs associated with the patient 110). In some instances, when a diagnoses is confirmed, all other potential causes of the symptoms may be removed from the medical case and the diagram 308 can be updated to include a single cause.

In the illustrated example, when the medical case associated with the patient 110 is identified by the case analyzer 208 as a complex case (e.g., a case not easily diagnosed and/or associated with a chronic condition), a status of the case profile associated with the patient 110 is set to an advanced research mode. Having a status of advanced research mode designates the patient 110 as one in need of additional, specialized assistance. Therefore, when the case profile of the patient 110 is set at advanced research mode, the patient 110 is provided with access to the example MCCM 104. Furthermore, in the illustrated example, the medical case associated with the patient 110 is stored and flagged in the example medical case registry 106 of FIG. 1 as a complex case. Furthermore, in the illustrated example, the research tool 200 recommends that the patient 110 (e.g., via the user interface 300 of FIG. 3) open a personal health record (PHR), if the patient 110 does not currently have a PHR.

FIG. 4 is a block diagram of an example apparatus that may be used to implement the example MCCM 104 of FIG. 1. The example MCCM 104 of FIG. 4 includes a decision support engine 400 having a personal health record (PHR) monitor 402, a specialist registry 404, a potential test module 406, links 408, and a social networking registry 410, and a communication module 412. While an example manner of implementing the MCCM 104 of FIG. 1 has been illustrated in FIG. 4, one or more of the elements, processes and/or devices illustrated in FIG. 4 may be combined, divided, re-arranged, omitted, eliminated and/or implemented in any other way. Further, the example decision support engine 400, the example case monitor 402, the example specialist registry 404, the example potential test module 406, the example links 408, the example social networking registry 410, the example communication module 412, and/or, more generally, the example MCCM 104 of FIG. 4 may be implemented by hardware, software, firmware and/or any combination of hardware, software and/or firmware. Thus, for example, any of the example decision support engine 400, the example case monitor 402, the example specialist registry 404, the example potential test module 406, the example links 408, the example social networking registry 410, the example communication module 412, and/or, more generally, the example MCCM 104 of FIG. 4 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example decision support engine 400, the example case monitor 402, the example specialist registry 404, the example potential test module 406, the example links 408, the example social networking registry 410, the example communication module 412, and/or, more generally, the example MCCM 104 of FIG. 4 are hereby expressly defined to include a tangible medium such as a memory, DVD, CD, etc., storing the software and/or firmware. Further still, the example decision support engine 400, the example case monitor 402, the example specialist registry 404, the example potential test module 406, the example links 408, the example social networking registry 410, the example communication module 412, and/or, more generally, the example MCCM 104 of FIG. 4 may include one or more elements, processes and/or devices in addition to, or instead of, those illustrated in FIG. 4, and/or may include more than one of any or all of the illustrated elements, processes and devices.

As described above, the example MCCM 104 provides the patient 110 with information useful to someone experiencing difficult in obtaining a diagnosis for one or more symptoms or conditions. The example decision support engine 400 of FIG. 4 monitors the medical case associated with the patient 110 and provides information to the patient based on the medical case. In particular, the case monitor 402 continuously monitors (e.g., by periodically polling) the case profiles 214 of the example DSARM 102 of FIG. 2 and the medical cases thereof. Additionally or alternatively, the example case monitor 402 may monitor one or more personal health records (PHRs) and the contents thereof (e.g., completed lab tests, structured discharge summary documents, family history information, etc.) to obtain updates on the treatment of the patient 110. The example decision support engine 400 updates its suggestions and provided information based on the updates obtained by the example case monitor 402. If the patient 110 is successfully diagnosed (e.g., a proper diagnoses is confirmed), the status of the medical case associated with the patient 110 can be changed to a treatment research and documentation mode. In such a mode, the suggestions provided by the example decision support engine 400 may be tailored to suggestions and/or advice regarding treatments and/or the research thereof.

When the patient 110 is determined to have a complex case (e.g., as indicated by the advanced research mode status in the corresponding case profile), the decision support engine 400 accesses the example potential tests 406 to determine which, if any, may be helpful in obtaining a diagnosis of the symptoms presented in the medical case of the patient 110. The example potential tests 406 can be generated by, for example, medical professionals and updated by the same. Referring to the example user interface 300 of FIG. 3, relevant one(s) of the potential tests 406, as identified by the decision support engine 400, can be presented to the patient 110 in a disease information center 310. The example disease information center 310 is a configurable application (or gadget) the displays information about selected diseases (e.g., the potential causes of the patient's 110 symptoms as listed in the list 306 and/or illustrated in the diagram 308). In the illustrated example, the disease information center 310 includes any of the potential tests 406 that may confirm or rule out one or more diagnoses for one or more of the potential causes identified in the medical case.

The example disease information center 310 can also be populated with information from the suggested links 408. The example suggested links 408 includes links to potentially useful resources such as, for example, a website of the Agency for Healthcare Quality and Research (AHRQ) and/or any other resource(s) that provide the patient, for example, best practice information, research studies, etc. The example suggested links 408 of FIG. 4 also include links (e.g., ClinicalTrials.gov) to information regarding ongoing clinical trials and/or experimental treatments related to the potential causes of the patient's 110 symptoms.

The example disease information center 310 of FIG. 3 can also be populated with information from the social networking registry 410. While the social networking registry 410 can include any type of social networks (e.g., networks within Facebook®, myspace.com®, Twitter®, YouTube®, etc.), the example social networking registry 410 of FIG. 4 includes, among others, a plurality of health-related social networks (e.g., PatientsLikeMe®, which can be found at http://www.patientslikeme.com, Trusera®, which can be found at http://blog.trusera.com, Medstory®, which can be found at http://www.medstory.com Yahoo® Health Groups, etc.). The example social network registry 410 includes contact information for different social networks dedicated to the diseases listed in the potential causes of the medical case associated with the patient 110.

The example disease information center 310 of FIG. 3 can also be populated with information from the specialist registry 404. The example specialist registry 404 includes a database of medical specialists. The example decision support engine 400 accesses the specialist registry 404 and identifies specialist(s) therefrom that are, for example, within a geographic area including the patient 110, within a healthcare plan associated with the patient 110, and/or will be specifically useful to the patient 110 (e.g., a specialist that expressed and documented an interest in medical cases similar to that of the patient 110 with the example medical information system 110 of FIG. 1 described herein).

Based on the information described above, the example decision support engine 400 of FIG. 1 also populates a suggestions window 312 of the example user interface 300 of FIG. 3 with one or more suggestions for the patient 110. For example, the decision support engine 400 can populate the suggestions window 312 with information recommendations on information to enter (e.g., further symptoms or current conditions (e.g., a current temperature, pain estimates, etc.) into the example symptoms window 302) to assist in the diagnoses. That is, the example decision support engine 400 recommends information that, if the patient 110 is able to provide it, narrows the potential causes of the symptoms. Additional or alternative information can be presented to the patient 110 in the suggestions window 312 (e.g., a most likely cause and/or recommendations for following up with a specialist).

Furthermore, the example decision support engine 400 access the example medical case registry 106 of FIG. 1 to gather statistics related to the medical case associated with the patient 110. In the illustrated example, the medical case registry 106 provides the decision support engine with information related to how many other patients have experienced similar or matching cases as the patient 110. The example user interface 300 includes a statistics section 314 to present such information to the patient 110.

The communication module 412 of the example MCCM 104 of FIG. 2 enables the patient 110 to request the assistance of and/or communicate with one or more specialists such as, for example, specialist(s) recommended by the decision support engine 400 from the specialist registry 404 (e.g., specialists within a healthcare plan or network associated with the patient 110). The example communication module 412 also enables specialists to communicate with the patient 110 and/or other patients determined (e.g., by the example DSARM 102) to have complex cases (e.g., as indicated by the status of the corresponding case profiles 214). Therefore, the example communication module 412 provides the patient 110 with access to a large number of specialists that are otherwise inaccessible to the patient 110, and provides specialists with access to patients having interesting, complex cases that can further the specialists' knowledge and/or understanding of certain diseases. The communication module 412 can provide secure communications that protect the privacy of the patient 110, the specialists, and/or any other involved party. The example communication module 412 and the operation(s) thereof are described in greater detail below in connection with FIG. 5.

FIG. 5 shows an example screenshot of an example user interface 500 implemented in connection with the example MCCM 104 of FIGS. 1 and/or 4 or, more particularly, the example communication module 412. The example user interface 500 of FIG. 5 includes a potential causes section 502, which includes information similar to that of the diagram 308 of FIG. 3. In the illustrated example, the potential causes section 502 includes a Venn diagram generated by the example diagram generator 210 of FIG. 2 and stored in the medical case associated with the patient 110 in the example case profiles 214 of FIG. 2. Additional or alternative information (e.g., the example list 306 of FIG. 3) can be included in the potential causes section 502.

The example user interface 500 of FIG. 5 also includes an area of interest section 504. In the illustrated example, the area of interest section 504 includes a template formed as the human body. The example communication module 412 can determine which body part is involved by analyzing the medical case associated with the patient. Further, the communication module 412 includes an indication (e.g., a circle or different coloring or shading) on the template of that or those body part(s). The example user interface 500 of FIG. 5 also includes a test section 506 including a list of tests and/or the results thereof. To populate the example test section 506, the communication module 412 can access one or more personal health records (PHRs) associated with the patient 110 and can updated the same accordingly.

The example user interface 500 of FIG. 5 also includes a list of collaborators 508 indicative of individuals and/or groups that have contributed to the exchange of information regarding the medical case of the patient 110. In the illustrated example, the list of collaborators 508 includes the patient 110, a dermatologist, and a rheumatologist. Additional collaborators can be added as more individual and/or groups contribute the collaboration on diagnosing the patient 110. The example user interface 500 includes an invite option 510 to enable the patient 110 to invite specialist(s) to the collaboration implemented by the communication module 412. For example, the patient 110 may invite one or more of the specialists recommended by the decision support engine 400.

Further, the example user interface 500 includes a sharing option 512 to enable the patient 110 and/or the specialists add a comment, analysis, and/or any other type of communication to a thread 514. The example thread 514 and the communication thereof can be implemented by, for example, a technology similar to that of Google® Wave® and/or any other program or application that enables an ongoing exchange of communications between the patient 110 and the specialist(s). Additionally, the patient 110 can control what information is shared in the example thread 514 (e.g., by determining which of the collaborators can view one or more entries of the thread 514). A playback option 516 enables the patient 110 and/or specialists to replay conversations that have already taken place (e.g., and are recorded and stored).

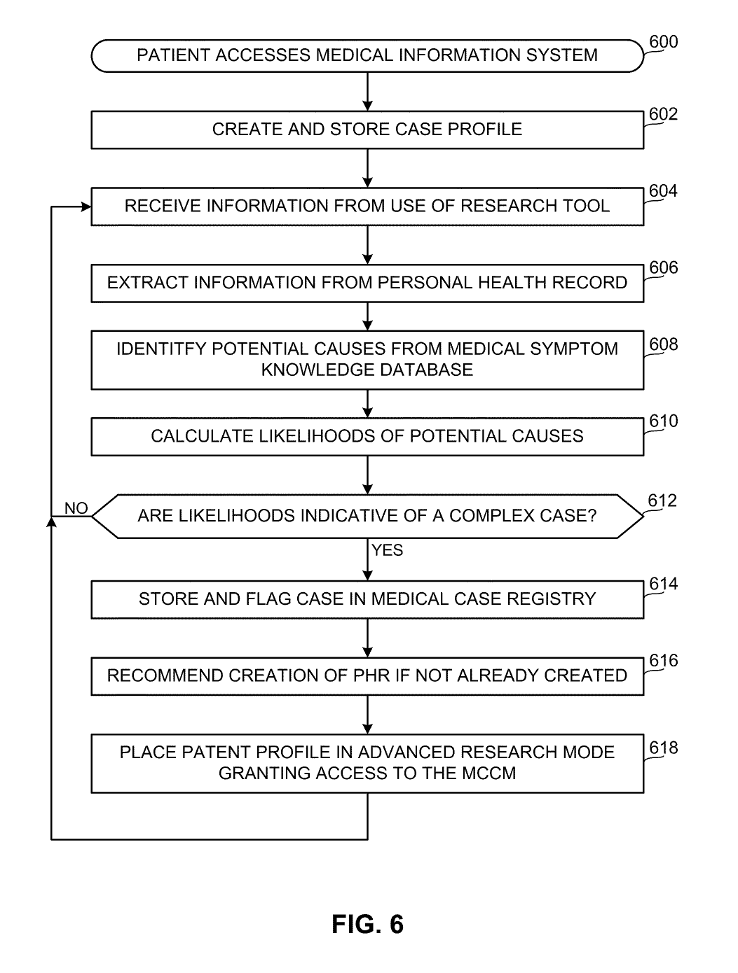

FIG. 6 is a flow diagram representative of example machine readable instructions that may be executed to implement the example DSARM 102 of FIGS. 1 and/or 2. The example processes of FIG. 6 may be performed using a processor, a controller and/or any other suitable processing device. For example, the example processes of FIG. 6 may be implemented in coded instructions stored on a tangible medium such as a flash memory, a read-only memory (ROM) and/or random-access memory (RAM) associated with a processor (e.g., the example processor 812 discussed below in connection with FIG. 8). Alternatively, some or all of the example processes of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 6 may be implemented manually or as any combination(s) of any of the foregoing techniques, for example, any combination of firmware, software, discrete logic and/or hardware. Further, although the example processes of FIG. 6 are described with reference to the flow diagram of FIG. 6, other methods of implementing the processes of FIG. 6 may be employed. For example, the order of execution of the blocks may be changed, and/or some of the blocks described may be changed, eliminated, sub-divided, or combined. Additionally, any or all of the example processes of FIG. 6 may be performed sequentially and/or in parallel by, for example, separate processing threads, processors, devices, discrete logic, circuits, etc.

At the onset of the example of FIG. 6, the patient 110 accesses the example medical information system 100 of FIG. 1 (block 600). In the illustrated example, the patient 110 accesses the example research tool 200 of the example DSARM 102. The example research tool 200 creates a case profile and stores the same in the case profiles 214 using biographic or demographic information provided by the patient 110 (block 602). As described above, the research tool 200 enables the patient 110 to enter information related to a health issue (block 604). For example, the patient 110 can enter a list of symptoms and/or conditions into the symptoms window 302 of the example user interface 300 of FIG. 3.

To build the medical case associated with the patient 110, the example medical case builder 202 extracts information related to the patient 110 (block 606). In the illustrated example of FIG. 6, the extracted information is retrieved by the PHR extractor 204 from one or more PHRs associated with the patient 110. Using the information entered by the patient 110 and the information extracted from the PHR(s), if any, the example medical case builder 202 access the example symptoms knowledge database 206 of FIG. 2 (and/or any other resource including information on relationships between symptoms and possible underlying causes) to identify any potential causes of the symptoms and/or conditions of the medical case (block 608).

The case analyzer 208 uses the medical case associated with the patient 110, including the information from the symptoms knowledge database 206, to generate calculate a likelihood for each of the potential cause(s) identified above (block 610). Each calculated likelihood reflects a probability that the corresponding cause is the correct diagnosis. When the likelihoods indicate that the medical case is not a complex case (e.g., as determined by the case analyzer 208 and one or more categorizations thereof) (block 612), the research tool 200 continues to receive input from the patient 110 and the PHR(s) associated with the patient 110 continued to be monitored (blocks 604 and 606). When the likelihoods indicate that the medical case is a complex case (block 612), the medical case associated with the patient 110 is stored and flagged as complex in the medical case registry 106 (block 614). As described above, the medical case registry 106 can be used by, for example, the clinical researcher 118 to perform studies, gather statistics, etc. Further, the research tool 200 recommends that the patient 110 open a PHR if a PHR has not been previously opened (block 616).

The status of the case profile associated with the patient 110 is then changed to advanced research mode, thereby granting the patient 110 access to the example MCCM 104 (block 616). As described above, the example MCCM 104 provides a plurality of services useful to a patient and/or specialist involved in complex health issues (e.g., chronic conditions and/or symptoms that are difficult to diagnose).

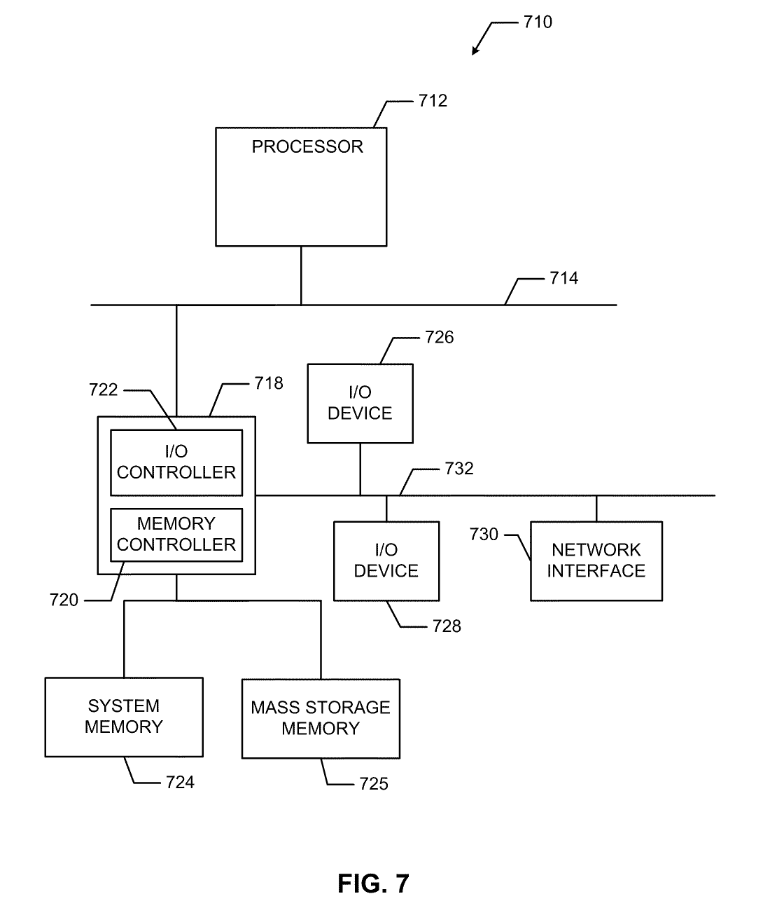

FIG. 7 is a block diagram of an example processor system 710 that may be used to implement the apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method to provide medical case research and collaboration, comprising:
receiving, by a processor, information from a person via a research tool related to one or more health issues of the person;
generating a medical case based on the information received from the person;
calculating one or more likelihoods associated with one or more potential causes of the health issues, wherein a first one of the likelihoods indicates a probability that a first one of the potential causes of the health issue is an accurate diagnosis;
determining whether the one or more likelihoods indicate that the medical case is complex; and
when the medical case is complex, granting the person access to a collaboration module.

2. A computer implemented method as defined in claim 1, further comprising extracting data from a personal health record associated with the person and generating the medical case based on the extracted data.

3. A computer implemented method as defined in claim 1, further comprising generating a graphical representation of the likelihoods and presented the graphical representation via the research tool.

4. A computer implemented method as defined in claim 1, further comprising storing the medical case in a medical case registry accessible by a clinical researcher.

5. A computer implemented method as defined in claim 1, wherein the collaboration module provides the person with a list of specialists having access to the collaboration module.

6. A computer implemented method as defined in claim 5, wherein the collaboration module includes a communication module to enable the person to communicate with the specialists on an ongoing basis via a thread.

7. A computer implemented method as defined in claim 5, wherein the list of specialists includes specialists within a healthcare network of the person.

8. A computer implemented method as defined in claim 1, further comprising providing the person with suggestions, based on the medical case, to narrow the potential causes for a diagnosis.

9. A computer implemented method as defined in claim 1, further comprising notifying the person of one or more social networks related to the medical case of the person.

10. A tangible machine readable medium having instructions stored thereon that, when executed, cause a machine to:
receive information from a person via a research tool related to one or more health issues of the person;
generate a medical case based on the information received from the person;
calculate one or more likelihoods associated with one or more potential causes of the health issues, wherein a first one of the likelihoods indicates a probability that a first one of the potential causes of the health issue is an accurate diagnosis;
determine whether the one or more likelihoods indicate that the medical case is complex; and
when the medical case is complex, grant the person access to a collaboration module.

11. A tangible machine readable medium as defined in claim 8 having instructions stored thereon that, when executed, cause a machine to extract data from a personal health record associated with the person and to generate the medical case based on the extracted data.

12. A tangible machine readable medium as defined in claim 8 having instructions stored thereon that, when executed, cause a machine to generate a graphical representation of the likelihoods and presented the graphical representation via the research tool.

13. A tangible machine readable medium as defined in claim 8 having instructions stored thereon that, when executed, cause a machine to store the medical case in a medical case registry accessible by a clinical researcher.

14. A tangible machine readable medium as defined in claim 8, wherein the collaboration module provides the person with a list of specialists having access to the collaboration module.

15. A tangible machine readable medium as defined in claim 12, wherein the collaboration module includes a communication module to enable the person to communicate with the specialists on an ongoing basis via a thread.

16. A tangible machine readable medium as defined in claim 12, wherein the list of specialists includes specialists within a healthcare network of the person.

17. An apparatus to provide medical case research and collaboration, comprising:
a research tool to receive information from a person related to one or more health issues of the person;
a medical case builder to generate a medical case based on the information received from the person;
a case analyzer to calculate one or more likelihoods associated with one or more potential causes of the health issues, wherein a first one of the likelihoods indicates a probability that a first one of the potential causes of the health issue is an accurate diagnosis, and wherein the case analyzer is to determine whether the one or more likelihoods indicate that the medical case is complex, and wherein the case analyzer is to grant the person access to a collaboration module when the case analyzer determines that the medical case is complex.

18. An apparatus as defined in claim 15, further comprising a personal health record extractor to extract data from a personal health record associated with the person, wherein the medical case builder is to generate the medical case based on the extracted data.

19. An apparatus as defined in claim 15, further comprising a diagram generator to generate a graphical representation of the likelihoods and to present the graphical representation via the research tool.

20. An apparatus as defined in claim 15, further comprising a medical case registry in communication with the apparatus, wherein the medical case is to be stored in the medical case registry, which is accessible by a clinical researcher.

21. An apparatus as defined in claim 15, wherein the collaboration module provides the person with a list of specialists having access to the collaboration module.

22. An apparatus as defined in claim 19, wherein the collaboration module includes a communication module to enable the person to communicate with the specialists on an ongoing basis via a thread.

23. An apparatus as defined in claim 15, wherein the collaboration module provides the person with one or more graphics corresponding to information of the medical case.

24. An apparatus as defined in claim 15, further comprising a decision support engine to provide the person with one or more suggestions to narrow the potential causes for a diagnosis.
